(19) United States
(12) Patent Application Publication
(10) Pub. No.: US 2025/0252285 A1
(43) Pub. Date: Aug. 7, 2025

(54) METHOD OF TESTING DETECTION MODELS BASED ON NEURAL NETWORK, ELECTRONIC DEVICE, AND COMPUTER READABLE STORAGE MEDIUM THEREOF

(71) Applicant: HON HAI PRECISION INDUSTRY CO., LTD., New Taipei (TW)

(72) Inventors: KUO-FONG TSENG, New Taipei (TW); YU-TING LIAO, New Taipei (TW)

(21) Appl. No.: 19/018,695

(22) Filed: Jan. 13, 2025

(30) Foreign Application Priority Data
Feb. 6, 2024 (CN) 202410170658.0

(51) Int. Cl. G06N 3/04

(52) U.S. Cl. CPC G06N 3/04

(57) ABSTRACT

A method of testing detection models based on a neural network includes that (a) acquiring to-be-detected data; (b) inputting the to-be-detected data into the primary hidden layer to generate primary output vectors; (c) determining whether an error of the to-be-detected data is larger than a predefined threshold; (d) when the error of the to-be-detected data is larger than the predefined threshold, returning to the step (a); (e) when the error of the to-be-detected data is less than or equal to the predefined threshold, outputting the primary output vectors into a next secondary hidden layer in sequence to generate corresponding secondary output vectors; (f) determining whether a detection result outputs based on the secondary output vectors. An electronic device and a computer readable storage medium are also provided.

### TECHNICAL FIELD

The present application generally relates to vehicle controlling technology, and particular to a method of testing detection models based on a neural network, an electronic device, and a computer readable storage medium thereof.

### BACKGROUND

Detection models based on a neural network, generally includes several hidden layers. On one hand, the hidden layers in the middle fail to test a quality of to-be-detected signals, thus a computing process of each detection result cost a lot of computing power. On another hand, when there are interference signals in the to-be-detected signals, there is large errors existed in the finally outputted detection result even setting the several hidden layer, even the detection result is failed to be outputted, and a time and a computing power are wasted.

There is room for improvement in the art.

### BRIEF DESCRIPTION OF THE DRAWINGS

Implementations of the present application will now be described, by way of example only, with reference to the attached figures.

FIG. 1 is a flowchart illustrating an embodiment of a method of testing detection models according to the present application.

FIG. 2 is a diagram illustrating an embodiment of a neural network applied the method of FIG. 1 according to the present application.

FIG. 3 is a diagram illustrating an embodiment of an electronic device applied the method of FIG. 1 according to the present application.

### DETAILED DESCRIPTION

For clarity, of illustration of objectives, features and advantages of the present application, the drawings combined with the detailed description illustrate the embodiments of the present application hereinafter. It is noted that embodiments of the present application and features of the embodiments can be combined, when there is no conflict.

The technical solutions in the embodiments of the present application will be described clearly and completely in conjunction with the accompanying drawings in the embodiments of the present application. Obviously, the described embodiments are only a part of the embodiments of the present application, rather than all the embodiments. Based on the embodiments of the present application, all other embodiments obtained by those of ordinary skill in the art without creative work shall fall within the protection scope of the present application.

Unless otherwise defined, all technical and scientific terms used herein have the same meaning as commonly understood by those skilled in the technical field of the present application. The terms used in the specification of the present application herein are only for the purpose of describing specific embodiments, and are not intended to limit the present application.

In general, the word “module,” as used herein, refers to logic embodied in hardware or firmware, or to a collection of software instructions, written in a programming language, for example, Java, C, or assembly. One or more software instructions in the modules may be embedded in firmware, such as an EPROM, magnetic, or optical drives. It will be appreciated that modules may comprise connected logic units, such as gates and flip-flops, and may comprise programmable units, such as programmable gate arrays or processors, such as a CPU. The modules described herein may be implemented as either software and/or hardware modules and may be stored in any type of computer-readable medium or other computer storage systems. The term “comprising” means “including, but not necessarily limited to”; it specifically indicates open-ended inclusion or membership in a so-described combination, group, series, and the like. The application is illustrated by way of example and not by way of limitation in the figures of the accompanying drawings in which like references indicate similar elements. It should be noted that references to “an” or “one” embodiment in this application are not necessarily to the same embodiment, and such references can mean “at least one.”

It is understood that, detection models based on a neural network, generally includes several hidden layers. On one hand, the hidden layers in the middle fail to test the quality of to-be-detected signals, thus a computing process of each detection result cost a lot of computing power. On another hand, when there are interference signals in the to-be-detected signals, there is large errors existed in the finally outputted detection result even setting the several hidden layer, even the detection result is failed to be outputted, and a time and computing power are wasted.

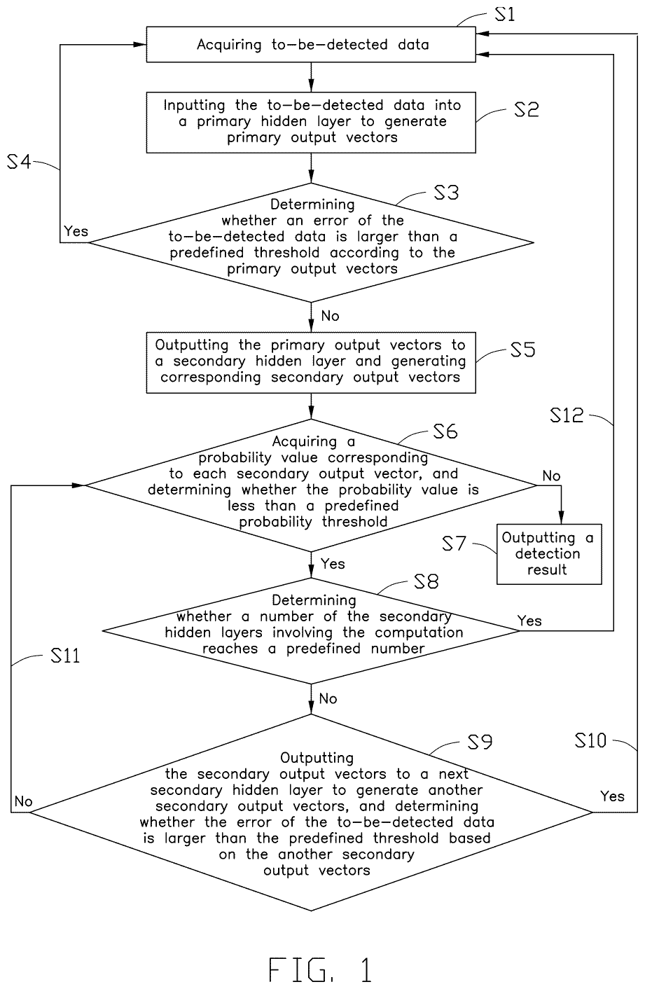

According to above, the present application provides a method of testing detection models, for reducing errors and an operand. As shown in FIG. 1, it shows a flowchart of the method of testing detection models. According to different requirements, the order of the steps in the flowchart can be changed, and fewer steps can be utilized with departing from this application.

It is understood that, the method provided by the present application is applied in the various methods based on a neural network. The present application does not limit an application field and an application apparatus of the method. For example, in the embodiment of the present application, the method is applied in a vehicle-mounted system. In other embodiments, the method based on the neural network provide by the present application also may be applied to an agricultural field for identifying plant diseases and insect pests or an industrial field for identifying flaw images.

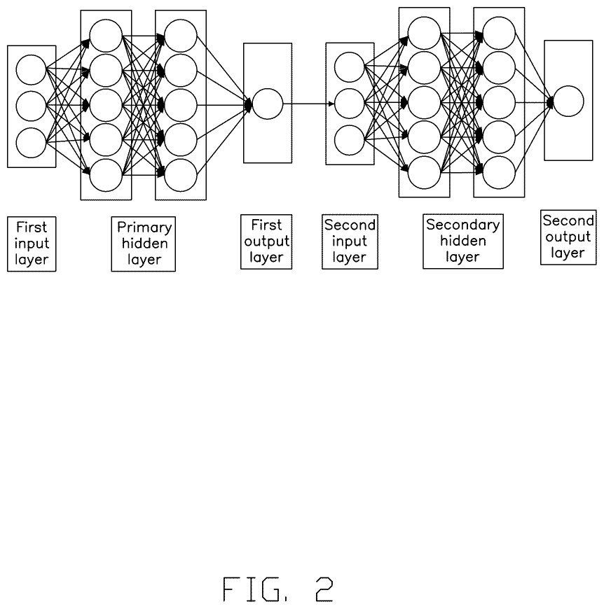

Referring to FIG. 2, in the embodiment of the present application, the neural network may include an input layer, a primary hidden layer, an output layer, a second input layer, a plurality of secondary hidden layers, and an output layer, which are arranged in that order. It is understood that, the neural network shown in FIG. 2, only illustrates a structure of the neural network, but does not limits various parameters (such as parameters of a height, a width, and a depth, and so on) and setting manner (such as a fully-connected manner or partially connected manner).

Further, the method based on the neural network may include the following steps.

In block S1, to-be-detected data are acquired.

In the embodiment of the present application, the vehicle-mounted system acquires the to-be-detected data by a lidar mounted on a vehicle, and the to-be-detected data are point cloud data.

It is understood that, the lidar, also known as optical radar, emits a laser to a target object, for determining parameters of the target object such as a distance, a size, and so on. In the embodiment of the present application, the vehicle senses surrounding road environment by the lidar mounted on the vehicle while the vehicle drives, thus point cloud data presenting the surroundings environment of the vehicle are established. The vehicle-mounted system analyzes the point cloud data for acquiring a corresponding road, a position of the vehicle, and an obstacle information, for adjusting driving parameters of the vehicle. Thus, the vehicle may be safely and reliably drive on the road until a predefined destination is arrived. However, due to a complex road environment while the vehicle driving, there are interference signals existed in the point cloud data acquired by the lidar, which effects the vehicle-mounted system in identifying of the road environment, even a safety driving may be affected.

In block S2, the to-be-detected data are inputted into a primary hidden layer to generate primary output vectors.

Referring to FIG. 2, the to-be-detected data in the blocks S1 and S2 are inputted into the primary hidden layer through the first input layer. The primary hidden layer may be a convolution layer. It is understood that, the convolution layer is configured to extract features of the inputted to-be-detected data. In the embodiment of the present application, the neural network applied the method may include two primary hidden layers.

In the block S2, the vehicle-mounted system inputs the acquired point cloud data into the primary hidden layers to generate primary vectors, which are the primary feature vectors of the to-be-detected data.

In block S3, determining whether an error of the to-be-detected data is larger than a predefined threshold according to the primary output vectors.

In the embodiment of the present application, after inputting into the primary hidden layer through the first input layer, the to-be-detected data are processed by the two primary hidden layer, and the primary output vectors are outputted by the first output layer.

In block S4, when the error of the to-be-detected data is larger than the predefined threshold, the procedure returns to the block S1 for re-acquiring the to-be-detected data.

In block S5, when the error of the to-be-detected data is less than or equal to the predefined threshold, the primary outputted vectors are inputted into a secondary hidden layer to generate secondary outputted vectors.

In some capable embodiments, in the block S3, the vehicle-mounted system compares the primary outputted vectors with the predefined outputted vectors without interference signals to obtain the error of the first outputted vectors.

In the block S3, when the error of the primary outputted vectors is larger than the predefined threshold, the vehicle-mounted system determines that the error of the to-be-detected data is larger than the predefined threshold, in that means, the interference signals included in the to-be-detected data is in an unacceptable range. Thus, the vehicle-mounted system returns to the block S1, the to-be-detected data is re-acquired for testing.

It is understood that, by returning to the block S1, when there are a large interference signals in the to-be-detected data while initially determined, the to-be-detected data is re-acquired for computing, for avoiding a detection result to be inaccuracy due to the large interference signals, which affects a driving safety, and for avoiding the neural network to execute a large computation using the to-be-detected data with the interference signals, which cause the waste in computing power and time.

In the block S3, when the error of the primary outputted vectors is less than or equal to the predefined threshold, the vehicle-mounted system determines that the error of the to-be-detected data is less than or equal to the predefined threshold, in that means, the interference signals in the to-be-detected data is in an acceptable range. Thus, the vehicle-mounted system executes the block S5, for inputting the primary outputted vectors into the secondary hidden layer by the second input layer to generate corresponding secondary output vectors.

In the embodiment of the present application, the secondary hidden layer is also a convolution layer, and is configured to extract other features of the to-be-detected data. Thus, the secondary output vectors also the features vectors presenting the to-be-detected vectors.

In block S6, a probability value corresponding to each secondary output vector is acquired, and determining whether each probability value is less than a predefined probability threshold.

Referring to FIG. 2, it is understood that, in some embodiments, there are an activation layer, a pooling layer, and a fully connected layer, which are disposed between the secondary hidden layer and the second output layer. In the block S6, the vehicle-mounted system inputs the secondary output vectors into the activation layer, through the pooling layer and the fully connected layer, the probability values are outputted by the second output layer. The sum of the probability values is less than 1.

In block S7, when the probability value is larger than or equal to the predefined probability threshold, a detection result is outputted.

For example, the predefined probability threshold is 95%, and after being computed by the activation layer, the pooling layer, and the fully connected layer, the capable obtained results may include that a probability value of the to-be-detected data to be an object A is 0.6%; a probability value of the to-be-detected data to be an object B is 1.4%, a probability value of the to-be-detected data to be an object C is 98%. In that means, the probability value of the to-be-detected data to be the object C is 98%, which is larger than the predefined probability threshold, thus the detection result outputted by the output layer is that the to-be-detected data is the object C.

In block S8, when the probability value is less than the predefined probability threshold, determining whether a number of the secondary hidden layers involving in a computation reaches a predefined number.

For example, in other embodiment, after the computing by the activation layer, the pooling layer, and the fully connected layer, the capable obtained result may include that a probability value of the to-be-detected data to be an object A is 10%; a probability value of the to-be-detected data to be an object B is 20%, a probability value of the to-be-detected data to be an object C is 70%. In that means, all the probability values of the to-be-detected data are less than the predefined probability threshold. Therefore, in the embodiment, while all the probability values of the to-be-detected data are less than the predefined probability threshold, the vehicle-mounted system determines whether the number of the secondary hidden layers involving in the computation reaches the predefined number.

In one embodiment of the present application, the predefined number is 3. In that means, when all the probability values of the to-be-detected data are less than the predefined probability threshold, the vehicle-mounted system determines whether the number of the secondary hidden layers involving in the computation reaches 3 layers.

In block S9, when the number of the secondary hidden layers involving in the computation is less than the predefined number, the secondary output vectors are outputted to a next secondary hidden layer, and other corresponding secondary output vectors are generated, and determining whether an error of the to-be-detected data is larger than the predefined threshold according to the other secondary output vectors.

It is understood that, in the block S7, when all the probability values are less than the predefined probability threshold, it means that it is not enough to obtain the detection result of the to-be-detected data by using the primary hidden layer and one secondary hidden layer. Therefore, using the other secondary hidden layer in the block S9, the related features of the to-be-detected data are further extracted, which is used for further determining the detection result.

In block S10, when the error of the to-be-detected data is larger than the predefined threshold according to the other secondary output vectors, the procedure returns to the block S1, for re-acquiring the to-be-detected data.

It is understood that, in the block S10, the vehicle-mounted system compares the secondary output vectors with the predefined secondary output vectors to obtain an error of the other secondary output vectors. It is understood that, when the error of the other secondary output vectors is larger than the predefined threshold, it means that the to-be-detected data includes a large interference signals, and need to be re-acquired.

In block S11, when the error of the to-be-detected data based on the other secondary output vectors is less than or equal to the predefined threshold, the procedure returns to the block S6, until the number of the secondary hidden layer involving in the computation reaches the predefined number.

It is understood that, when the error of the to-be-detected data based on the other secondary output vectors is less than or equal to the predefined threshold, it means that the interference signals in the acquired to-be-detected data in the block S1 is in the acceptable range. Thus, the procedure returns to the block S6 for determining whether the detection result outputs based on the other secondary output vectors.

In block S12, when the number of the secondary hidden layers involving the computation is larger than or equal to the predefined number, the procedure returns to the block S1.

It is understood that, in the block S12, when the number of the secondary hidden layers involving the computation is larger than or equal to the predefined number, and no detection result satisfied with predefined probability threshold is obtained, it also means that the acquired to-be-detected data in the block S1 includes the large interference signals. Thus, the vehicle-mounted system returns to the block S1 and re-acquires the to-be-detected data for determining the detection result.

It is understood that, according to different application fields or apparatus, in some embodiments, the to-be-test data may be two-dimensional image data being grayscale processed. The application does not limit the type of the to-be-detected data.

It is understood that, in some embodiments, after the block S6, in the block S8, when the number of the secondary hidden layers involving the computation does not reach the predefined number, the secondary output vectors are outputted to the next secondary hidden layer to generate the other secondary output vectors, and the procedure returns to the block S6, and acquires the probability value corresponding to the other secondary output vectors, for determining whether the detection result outputs. Therefore, in the embodiments, the time and computing power are further saved.

It is understood that, the present application does not limit a method of determining whether the error of the to-be-detected data is larger than the predefined threshold, the person skilled in the related art may adjust the method of determining the error based on an actual requirement. For example, in some embodiments, the probability value corresponding to the primary output vectors or the secondary output vectors are acquired, and when the probability value is less than the another predefined probability threshold, it determines that the error of the to-be-detected data is larger than the predefined threshold. It is understood that, the another predefined probability threshold is less than the predefined probability threshold in the block S6.

It is understood that, in one hand, the present application provides a method of testing detection models based on the neural network pre-computes the error of the output vectors of the hidden layer for determining whether the to-be-detected data includes a large interference signals. When the number of the interference signals included in the to-be-detected data is in the unacceptable range, the to-be-detected data are re-acquired, for reducing an operand. In another hand, the probability values of the output vectors are computed for flexible deciding the number of the hidden layers involving the computation, for further reducing the operand.

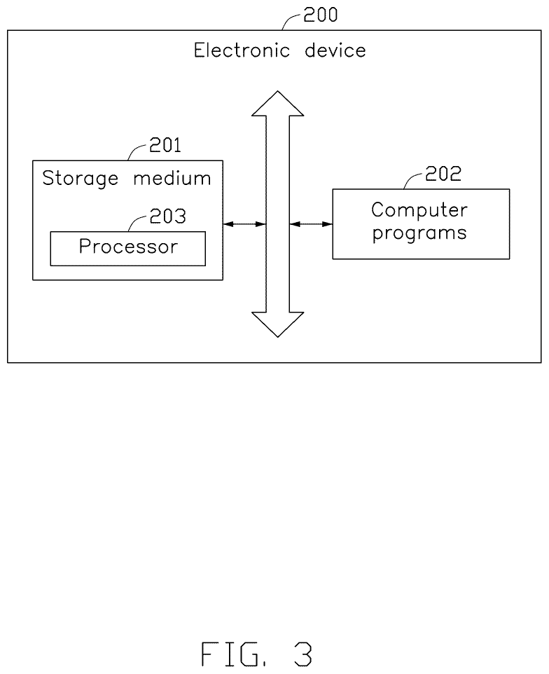

Referring to FIG. 3, the embodiment of the present application also provides an electronic device 200. The electronic device 200 includes a storage medium 201, a processor 202, and computer programs 203, which are stored in the storage medium 201 and may by run by the processor 202.

The electronic device 200 may be one of a cloud system, an embedded computer, and a vehicle-mounted system, or a server. A person skilled in the art can understand that, a structure shown in the figure does not constitute a limitation on the electronic device 100, and the electronic device 200 may include components that are more or fewer than those shown in the figure, or a combination of some components, or different component arrangements.

The processor 202 is configured to execute the computer programs 203 to implement the steps of the detection method in the above embodiment such as blocks S1˜S12 of the first embodiment.

Exemplary, the computer programs 203 may be divided into one or more modules/units, and the one or more modules/units are stored in the storage medium 201 and executed by the processor 202 to complete this application. The one or more modules/units can be a series of computer program instruction segments capable for performing a specific function which used to describe the execution of computer programs 203 in electronic device 200.

The processor 202 may be a central processing unit (CPU), other general-purpose processors, a digital signal processor (DSP), an application specific integrated circuit (ASIC), field-programmable gate array (FPGA) or other programmable logic devices, discrete gates or transistor logic devices, discrete hardware components, and so on. The general-purpose processor can be a microprocessor or the processor can be any general processor, and so on. The processor 202 is a control center of the electronic device 200, and is connected to various parts of the entire electronic device 200 by using various interfaces and lines.

The storage medium 201 may be used to store computer programs 203 and/or modules/units. The processor 202 may implements various functions of the electronic device 200 by running or executing the computer programs 203 and/or module stored in the storge medium 201 and by invoking data stored in the storage medium 201. The storage medium 201 may mainly include a program storage area and a data storage area, the program storage area may store an operating system and application programs required by at least one function (such as a sound playback function, an image playback function, and so on); the data storage area may store data created by the use of the electronic device 200 (such as audio data, phone books, and so on). In addition, the storage medium 201 may include a cache random access memory, and include a non-transitory memory, such as a hard disk, a memory, a plug-in hard disk, a Smart Media Card (SMC), a Secure Digital (SD) card, a flash card, at least one disk memory device, a flash memory device, or other volatile solid-state memory device.

In one embodiment of the present application, the electronic device 200 is a mobile apparatus, such as a vehicle, and so on.

When the program codes and various data in the storage medium 201 are implemented in a form of a software functional unit and sold or used as an independent product, the program code and various data may be stored in a computer-readable storage medium. Based on such understanding, some or all of the processes for implementing the methods in the embodiments of this application may be completed by related hardware instructed by the computer programs 203. The computer programs 203 may be stored in a computer-readable storage medium. When the computer programs 203 are executed by the processor 202, the steps of the foregoing method embodiments are implemented. The computer programs 203 include computer program codes, and the computer program codes may be in a form of source code, object code, or an executable file, some intermediate forms, or the like. The computer readable medium may include: any entity or apparatus capable of carrying the computer program codes, a recording medium, a USB flash drive, a removable hard disk, a magnetic disk, an optical disc, a computer memory, a read-only memory (ROM, Read-Only Memory), an electric carrier signal, a telecommunications signal, and a software distribution medium, and so on. It should be noted that content contained in the computer-readable medium can be appropriately added or deleted in accordance with requirements of legislation and patent practices in the jurisdiction. For example, in some jurisdictions, according to the legislation and patent practices, the computer-readable medium does not include electrical carrier signals and telecommunication signals.

In the embodiments provided in the present application, it should be understood that the disclosed electronic device and method may be implemented in other ways. For example, the above-described electronic device embodiments are merely illustrative, and for example, a module or a unit may be divided into only one logical function, and may be implemented in other ways.

In addition, functional units in the embodiments of the present application may be integrated into one processing unit, or each unit may exist alone physically, or two or more units are integrated into one unit. The integrated unit can be realized in a form of hardware, and can also be realized in a form of a software functional unit.

For those skilled in the art, apparently the present application is not limited to the details given in the above exemplary embodiments. The present application can be embodied in other specific forms without departing from the spirit or essential characteristics of the application. Therefore, the embodiments shall be considered as exemplary and unrestricted in any way. The scope of the application is defined by the appended claims rather than the above description. Hence, all changes intended to come within the meaning and range of equivalent elements of the claims shall be included within the application. Any marks on drawings to the Claims shall not be construed as limiting the Claims involved. Besides, it is apparent that the term “comprise” does not exclude other modules or steps, and singularity does not exclude plurality. A plurality of units or modules stated in an electronic device claim may also be implemented by a single unit or module through software or hardware. Terms such as the first and the second are used to indicate names, but do not indicate any particular sequence.

Finaly, the embodiments described above are provided by way of example only, and various other modifications will be apparent to persons skilled in the field without departing from the scope of the application as defined by the appended claims. It will be appreciated that, numerous variations and substitutions will occur to those skilled in the art without departing from the scope of the disclosure. Those variations and substitutions made in accordance with the spirit of the disclosure are within the scope of the present disclosure.

What is claimed is:

1. A method of testing detection models based on a neural network used in an electronic device, the neural network comprises a primary hidden layer and a plurality of secondary hidden layers, which are connected with each other in sequence; the electronic device comprises a processor and a storage medium; the processor executes computer programs stored in the storage medium to implement following processes:
(a) acquiring to-be-detected data;
(b) inputting the to-be-detected data into the primary hidden layer to generate primary output vectors;
(c) determining whether an error of the to-be-detected data is larger than a predefined threshold;
(d) when the error of the to-be-detected data is larger than the predefined threshold, returning to the step (a);
(e) when the error of the to-be-detected data is less than or equal to the predefined threshold, outputting the primary output vectors into one of the plurality of the secondary hidden layers in sequence to generate corresponding secondary output vectors; and
(f) determining whether a detection result outputs based on the secondary output vectors.

2. The method of claim 1, wherein determining whether the detection result outputs based on the secondary output vectors comprises:
acquiring a probability value corresponding to each secondary output vector;
when the probability value is larger than or equal to a predefined probability threshold, the detection result outputs.

3. The method of claim 2, wherein when the probability value is less than the predefined probability threshold, the method further comprises:
determining whether a number of the secondary hidden layers involving the computation reaches a predefined number;
when the number of the secondary hidden layers involving the computation less than the predefined number, outputting the secondary output vectors to a next secondary hidden layer to generate other secondary output vectors;
determining whether an error of the to-be-detected data is larger than a predefined threshold based on the other secondary output vectors;
when the error of the to-be-detected data is larger than a predefined threshold based on the other secondary output vectors, returning to the step (a); and
when the error of the to-be-detected data is less than or equal to the predefined threshold based on the other secondary output vectors, returning to the step (f), until the number of the secondary hidden layers involving the computation reaches the predefined number.

4. The method of claim 3, wherein the method further comprises:
when the number of the secondary hidden layers involving the computation reaches the predefined number, returning to the step (a).

5. The method of claim 3, wherein the predefined number is 3.

6. The method of claim 1, wherein the primary hidden layer comprises at least one convolution layer.

7. The method of claim 1, wherein each secondary hidden layer comprises at least one convolution layer.

8. The method of claim 1, wherein the neural network further comprises an activation layer, a pooling layer, and a fully connected layer, which are disposed between the secondary hidden layer and the second output layer; before outputting the detection result, the method further comprises:
outputting the secondary output vectors to the activation layer, through the pooling layer and the fully connected layer, the probability values are outputted by the second output layer.

9. An electronic device comprises:
a storage medium; and
at least one processor;
wherein the storage medium stores computer programs; and the at least one processor executes the computer programs to implement following processes:
(a) acquiring to-be-detected data;
(b) inputting the to-be-detected data into a primary hidden layer of a neural network to generate primary output vectors; the neural network comprises further comprises a plurality of secondary hidden layers behind to the primary hidden layer, which are connected with each other in sequence;
(c) determining whether an error of the to-be-detected data is larger than a predefined threshold;
(d) when the error of the to-be-detected data is larger than the predefined threshold, returning to the step (a);
(e) when the error of the to-be-detected data is less than or equal to the predefined threshold, outputting the primary output vectors into one of the plurality of the secondary hidden layers in sequence to generate corresponding secondary output vectors; and
(f) determining whether a detection result outputs based on the secondary output vectors.

10. The electronic device of claim 9, wherein the processor further:
acquiring a probability value corresponding to each secondary output vector;
when the probability value is larger than or equal to a predefined probability threshold, the detection result outputs.

11. The electronic device of claim 10, wherein when the probability value is less than the predefined probability threshold, the processor further:
determining whether a number of the secondary hidden layers involving the computation reaches a predefined number;
when the number of the secondary hidden layers involving the computation less than the predefined number, outputting the secondary output vectors to a next secondary hidden layer to generate other secondary output vectors;
determining whether an error of the to-be-detected data is larger than a predefined threshold based on the other secondary output vectors;
when the error of the to-be-detected data is larger than a predefined threshold based on the other secondary output vectors, returning to the step (a); and
when the error of the to-be-detected data is less than or equal to the predefined threshold based on the other secondary output vectors, returning to the step (f), until the number of the secondary hidden layers involving the computation reaches the predefined number.

12. The electronic device of claim 11, wherein the processor further:
when the number of the secondary hidden layers involving the computation reaches the predefined number, returning to the step (a).

13. The electronic device of claim 11, wherein the predefined number is 3.

14. The electronic device of claim 9, wherein the primary hidden layer comprises at least one convolution layer.

15. The electronic device of claim 9, wherein each secondary hidden layer comprises at least one convolution layer.

16. The electronic device of claim 9, wherein the neural network further comprises an activation layer, a pooling layer, and a fully connected layer, which are disposed between the secondary hidden layer and the second output layer; before outputting the detection result, the method further comprises:
outputting the secondary output vectors to the activation layer, through the pooling layer and the fully connected layer, the probability values are outputted by the second output layer.

17. A computer readable storage medium comprises a storage medium and a processor; the storage medium stores instructions being executed by the processor to implement following processes:
(a) acquiring to-be-detected data;
(b) inputting the to-be-detected data into a primary hidden layer of a neural network to generate primary output vectors; the neural network comprises further comprises a plurality of secondary hidden layers behind to the primary hidden layer, which are connected with each other in sequence;
(c) determining whether an error of the to-be-detected data is larger than a predefined threshold;
(d) when the error of the to-be-detected data is larger than the predefined threshold, returning to the step (a);
(e) when the error of the to-be-detected data is less than or equal to the predefined threshold, outputting the primary output vectors into one of the plurality of the secondary hidden layers in sequence to generate corresponding secondary output vectors; and
(f) determining whether a detection result outputs based on the secondary output vectors.

18. The computer readable storage medium of claim 17, wherein determining whether the detection result outputs based on the secondary output vectors comprises:
acquiring a probability value corresponding to each secondary output vector;
when the probability value is larger than or equal to a predefined probability threshold, the detection result outputs.

19. The computer readable storage medium of claim 18, wherein when the probability value is less than the predefined probability threshold, the computer readable storage medium further:
determining whether a number of the secondary hidden layers involving the computation reaches a predefined number;
when the number of the secondary hidden layers involving the computation less than the predefined number, outputting the secondary output vectors to a next secondary hidden layer to generate other secondary output vectors;
determining whether an error of the to-be-detected data is larger than a predefined threshold based on the other secondary output vectors;
when the error of the to-be-detected data is larger than a predefined threshold based on the other secondary output vectors, returning to the step (a); and
when the error of the to-be-detected data is less than or equal to the predefined threshold based on the other secondary output vectors, returning to the step (f), until the number of the secondary hidden layers involving the computation reaches the predefined number.

20. The computer readable storage medium of claim 19, the computer readable storage medium further:
when the number of the secondary hidden layers involving the computation reaches the predefined number, returning to the step (a).
